(19) United States
(12) Patent Application Publication
(10) Pub. No.: US 2003/0076968 A1
(43) Pub. Date: Apr. 24, 2003

(54) Method and system of controlling automotive equipment remotely

(76) Inventor: Rodger H. Rast, Rancho Cordova, CA (US)

Correspondence Address: Rastar Corporation, Suite L, 11292 Coloma Rd., Gold River, CA, 95670, US

(21) Appl. No.: 10/279,480

(22) Filed: Oct. 23, 2002

Related U.S. Application Data
(60) Provisional application No. 60/346,753, filed on Oct. 23, 2001.

(51) Int. Cl. H04R 29/00; H04B 1/00

(52) U.S. Cl. 381/124; 381/56; 381/119

(57) ABSTRACT

A apparatus and method for providing enhanced utilization of transponder devices and for creating control embodiments that are particularly suited for use dynamically generating or controlling audio from a remote location. Transponders units are configured with trace buffers, external dynamic inputs, response delays, and other mechanisms to enhance utility. By way of example, the transponders are incorporated within embodiments such as a steering wheel, skateboard, or sensor glove controlled musical instrument, or control system. Other embodiments include a mix-memory audio system and an audio amplitude control solution for automobiles.

### CROSS-REFERENCE TO RELATED APPLICATIONS

This application claims priority from U.S. provisional application serial No. 60/346,753 filed on Oct. 23, 2001.

### STATEMENT OF FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention pertains generally to the generation and control of remote systems and more particularly to passive transponder devices for controlling automotive systems, labels, sensors, instrument input devices, and so forth.

2. Description of the Background Art

Systems are typically controlled utilizing wired interface inputs, such as switches potentiometers and so forth, or require that the remote interface be configured with its own source of power.

These various remote control devices have generally been constrained by having a bulky source of power, that needs to be either replaced or recharged, to provide for transmitting control information to a remote receiver. The advent of transponder technology has done little to alter the situation and applications for remote control may be utilized. It will be appreciated that a typical transponder is only capable of transmitting a predetermined response upon detection of a challenge transmission.

These limitations have required that the mounting of interface controls, such as in an automobile, typically require that wiring be connected from the audio component to the buttons, knobs, or other selectors within a user-interface. It has been difficult to route signals from a convenient location, such as the steering wheel, to an audio component. The problems associated with routing of signals has generally precluded the aftermarket incorporation of convenient controls that are not collocated with the audio equipment itself.

As can be seen, therefore, a need exists for enhanced forms of transponders to open up new applications for remotely controlling device. The method and system for controlling automotive equipment remotely, in accordance with the present invention satisfies that need, as well as others, and overcomes deficiencies in previously known techniques. A number of applications are described herein for transponder devices and for new applications that may utilize these devices.

### BRIEF SUMMARY

The present invention describes new transponder embodiments that provide a number of remote control capabilities, and describes heretofore unknown applications that may be facilitated by the new transponder embodiments. Additionally, other related embodiments are described which can be implemented in conjunction with, or separate from, described embodiments.

Transponders are described which are configured for dynamically sensing external inputs which are periodically, or upon reaching a threshold, communicated to a device to be controlled. These transponders are preferably configured as passive devices which receive external power inductively, or from an RF source, preferably the system being controlled.

Additional transponder aspects are described for providing group responsive capabilities, ID based responses (i.e. on printed labels), non-volatile display drive capability, and so forth.

An application embodiment is described within which a preferably passive transponder is configured for sensing external inputs and is mounted within an automobile for remotely controlling aspects of sounds systems, and other devices. One preferred mounting for the device is as an aftermarket steering wheel wrap that generates audio and/or audio control information, such as playing an instrument which over-rides or is mixed with other sound sources (i.e. radio, pre-programmed media, etc.).

An application embodiment is described for providing additional control of audio based devices in response to registered internal and/or external acoustics.

An application embodiment is described for providing user controlled dynamic modifications of music or other pre-programmed data streams.

Another application embodiment is described wherein an inexpensive RFID label is provided with added capabilities, including a non-volatile display wherein it can be remotely programmed to display a new value.

Another application embodiment is described in which a skateboard is configured with a device that generates audio and audio control information in response to the output of ride sensors, wherein music may be remotely controlled to follow the ride sequence. A similar audio control application is described in which a wearable sensing unit is configured to generate audio control information for generating audio and/or dynamic audio control in response to the sensed parameters.

It will be appreciated that a number of inter-related aspects are associated with the present invention, which may be applied to a number of situations without departing from the present invention. The objects of this invention include, but are not limited, to the following:

An object of the invention is to provide for the convenient control of automotive systems from a remote location.

Another object of the invention is to provide methods for remotely controlling the generation of audio.

Another object of the invention is to provide methods for remotely controlling the generation of audio from a self-powered remote device.

Another object of the invention is to provide passive sensing of external conditions in response to power received from a remote transceiver.

Another object of the invention is to provide a system that allows a user to play a simulated instrument on an automotive steering wheel, or similar convenient surface.

Another object of the invention is to provide the capability to provide locally programmed or dynamic information within the response to a challenge from a transceiver.

Another object of the invention is to provide enhanced transponder labels that are configured for recording a series of substantially unique challenges to facilitate tracking operations.

Another object of the invention is to provide enhanced transponder labels that are configured for sensing and communicating external characteristics in response to a challenge.

Another object of the invention is to provide enhanced transponder labels with a display, such as for indicating transponder activity, that can be modulated in response to a challenge.

Another object of the invention is to provide enhanced transponder labels with a non-volatile display that can be set in response to a challenge.

Another object of the invention is to provide a means by which an individual may dynamically modulate audio generation and/or control in response to dynamic motion.

Another object of the invention is to provide a means of controlling audio output in response to the riding of a skateboard, or similar transport device.

Another object of the invention is to provide a means of controlling audio output in response to the movement of an individual wearing a sensing device, such as gloves.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a schematic of an audio system receiving input from a steering wheel mounted interface device according to an embodiment of the present invention, showing an inductive communication connection.

FIG. 2 is a schematic of a transponder and a reader according to an aspect of the present invention,

FIG. 3 is a cross-section view of a sensor ridge for simulating a guitar string according to another aspect of the present invention, such as utilized for input to the device shown in FIG. 1.

FIG. 4 is a cross-section of a multiple layer, multiple threshold switch sensor according to an aspect of the invention for providing limited force feedback according to another aspect of the present invention.

FIG. 5 is a side view of a shift knob (manual or automatic) configured with inputs according to an aspect of the present invention, such as utilized for input to the device shown in FIG. 1.

FIG. 6 is a front view of the shifting knob of FIG. 5.

FIG. 7 is a plan view of a combination earpiece and microphone adapted for passive operation according to an aspect of the present invention.

FIG. 8 is a flowchart of the method for generating dynamic responses from a passive transponder element according to an aspect of the present invention.

FIG. 9 is a schematic of a transponder configured with a number of enhancements according to aspects of the present invention including, ID, eInk display driver, delay circuit, sense inputs, and printer programmable inputs (local programmable).

FIG. 10 is a plan view of a packaging label containing a transponder which drives low power display elements within the label according to an aspect of the present invention.

FIG. 11 is an exploded view of the label of FIG. 10.

FIG. 12 is a top view of a pre-printed stamp containing a transponder for registering a series of substantially unique challenges within a substantially non-volatile trace memory according to an aspect of the present invention.

FIG. 13 is a point-of-use printed stamp the includes a transponder with values encoded at the point of use, and may include a challenge trace memory, display, group response and other aspect according to the present invention.

FIG. 14 is a facing view of inventory control tags according to the present invention which incorporate sensors, herein shown for reporting fluid levels in response to a challenge.

FIG. 15 is a block diagram of an audio amplitude controller which modulates audio output in response to internal and/or external ambient conditions according to an aspect of the present invention and which can modulate audio output in response to specific audio patterns and conditions being detected, such as external siren audio.

FIG. 16 is a block diagram of a circuit for storing a user programmed dynamic modulation data stream for controlling dynamic modulation of audio generation and/or control according to an aspect of the invention, and shown for dynamically warping and otherwise modifying audio output in response to a user programmed sequence.

FIG. 17 is a top view of a skateboard having a sensing top and preferably other sensing inputs, and configured for dynamically modulating audio generation and/or control according to the dynamic parameters sensed during riding of the skateboard.

FIG. 18 is a schematic for a portions of a simplified switch matrix that may be utilized within the sensing skateboard top shown in FIG. 17.

FIG. 19 is a block diagram of a circuit within the skateboard of FIG. 17 shown for registering ride parameters and generating dynamic audio and/or audio control in response thereto, according to an aspect of the present invention.

FIG. 20 is a facing view of a wearable device for registering motion and generating dynamic audio and/or audio control in response thereto, according to another aspect of the present invention.

### DETAILED DESCRIPTION OF EMBODIMENT(S)

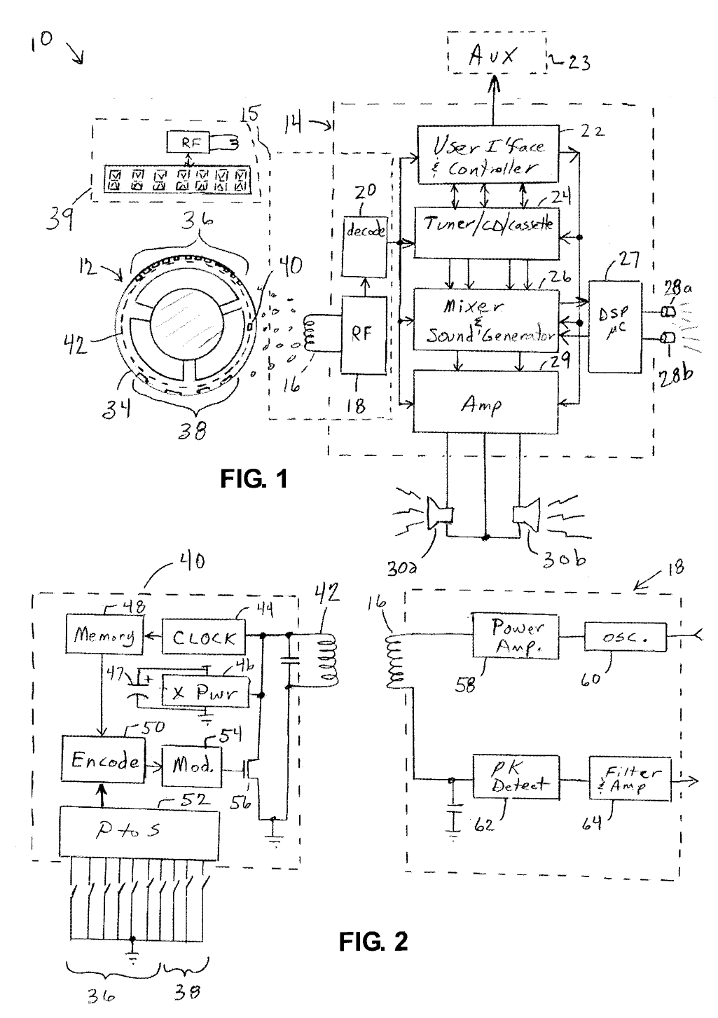

Referring more specifically to the drawings for illustrative purposes, the present invention is embodied in the apparatus generally shown in FIG. 1 through FIG. 20. The detailed description exemplifies specific embodiments of the invention which are described in sufficient detail so as to allow a person of ordinary skill in the art to practice the invention without undue experimentation. It will be appreciated that the apparatus may vary as to configuration and as to details of the parts without departing from the basic concepts as disclosed herein.

The system comprises a user input means configured for wireless communication with a remote device that is preferably configured for generating audio sequences for controlling aspects of audio sequences which are generated from other sources. A method and system are described for providing a user-interface for remotely controlling a number of types of audio equipment, or other systems in need of convenient local user control. The system is particular well suited for use within an automobile, and its use is exemplified therein.

The device provides for the convenient control of a number of automotive system features, for example, (1) audio system—control of volume, channel, equalization, program (generally set to a fixed desired level); (2) enhanced audio system—warping controls, music as played by driver on the device interface, vocals from the driver as coupled through a microphone in said device (dynamic generation of audio or control sequence); (3) communication equipment control—controlling the use of a cellular phone, including going off-hook, dialing, volume, hang-up, and so forth; (4) alarm control—panic button or auxiliary activation controls (a fixed command sequence); (5) miscellaneous controls—controlling the activation of shocks, lights, and sound sources within the vehicle.

The communication link from the user interface preferably comprises a transponder device that communicates by RF, inductive coupling, or similar means of establishing remote communication. Preferably, the transponder is self-powered from energy received from a transceiver that issues challenges, from an inductive power coupling, from a solar energy conversion device, or from combinations thereof. The most preferred configuration is with a transponder that receives operating power from the transmissions of a transceiver (reader) unit, which is either used immediately to respond to a received challenge, or to store energy so that an a transmission may be powered in response to an event, such as a significant change in state of user inputs.

By way of example and not of limitation, the present control method may be implemented as an interface within a steering wheel cover that mounts around the steering wheel. A transponder is located within the over-wrap that is responsive to signals generated by the equipment to be controlled, such as an audio system. Selection controls, inputs, on the steering wheel cover are connected to a transponder unit. The selection controls may be implemented in the form of switches or tactile sensors, such as membrane switches, force sensors, pressure sensors, or other user input sensors joined with the cover.

These switches (or sensors) can be configured in any desired configuration, as generally determined by the application to which they are applied. For example, all or a portion of the inputs may be configured to simulate the inputs of a musical instrument, wherein the user can play a tune on the steering wheel. As the user dynamically interacts with the interface a dynamic audio or audio control sequence are communicated to a receiving unit and audio corresponding to the tune is generated. The tune may be played solo, or in combination (i.e. mixed with) audio from one or more other sources, such as the radio or a pre-programmed media. The inputs, for example, may be configured as the keys on a piano (or organ, synthesizer keyboard, harpsichord, or other finger touch keys which produce different sounds), the pads for a drum (or xylophone, tambourine, clackers, or a other strike related instrument) as ridges simulating the strings on a guitar (guitar, banjo, or other stringed instrument), and similar musical functions.

In addition, the selection input controls to the unit can be utilized for dynamically controlling the output from an audio system, such as warping the sound output of a pre-recorded tune as it is played by an audio system. Furthermore, the input controls may be utilized for controlling auxiliary equipment, such as the dialing of a telephone, controlling lights, adjusting the audio controls and so forth.

It will be appreciated that the inputs to the unit may comprise switches, sensors, or similar input units capable of registering user interaction with the system. Conventional membrane switches, or other single state switches or threshold sensitive sensors, may be utilized for registering simple on/off values within the unit. One preferred form of pressure sensing comprises the use of a layered switch matrix to provide an inexpensive means for registering user input force, such as may be utilized for modulating the amplitude of the response, for instance the amplitude and attack of a piano note. Another form of preferred input sensing comprises the use protruding ridges configured on the perimeter of the wheel to simulate the strings of a guitar. Strumming of the ridge, with a force having a sufficient tangential component, activates the switch (or sensor) coupled (i.e. beneath) to the protruding ridge.

The unit registers the input, such as from the simulated piano keys, and communicates information to a remote unit, preferably an audio system or audio component interconnected with the audio system, and configured for generating audio output or dynamically controlling aspects of audio generated from another audio source, such as radio or pre-recorded audio content. The information communicated may comprise the raw data associated with the user input, or the inputs may be interpreted within the unit which can generate other forms of data communication. For example, the unit may transmit the key sequence as it is being played, or could process the key sequence relative to the application. An example of processed key input would be that of generating a simple note sequence in response to key activity, such as following a MIDI format, in response to playing of simulated “piano keys”, or other instrument.

It will be appreciated that the steering wheel mounted unit could generate and communicate synthesized audio, however, it will be appreciated that this would increase the necessary communication bandwidth. To minimize power consumption and bandwidth requirements within the input device, it is preferred that a simple encoding mechanism be utilized, such as just encoding the keystroke inputs.

The input interface preferably incorporates a transponder unit, which receives challenges from a transceiver unit that is in communication (i.e. RF, or inductively coupled) with the audio system. The transponder unit is preferably self-powered from the power received (inductively or by RF) from the transceiver. When the transceiver is activated, it can generate periodic transmissions as challenges to the transponder, to which the transponder can respond with the input “piano key” states (optionally unit IDs and other data may be communicated).

Within the present invention, the transponder may also be configured with an energy storage element, such as a capacitor, wherein it may store energy from the emanations of the transceiver for later use. The stored charge allow the interface unit to asynchronously generate an output in response to user input, wherein it need not wait until receipt of a subsequent challenge to generate information about a user activity event. This mode of operation can provide more accurate event timing while reducing the rate at which transmissions are generated by the transceiver for powering the transponder. Another aspect of this mode is that the transponder may optionally encode a power level parameter to the transceiver which allows the transceiver to gauge when it will next need to transmit to retain sufficient power at the transceiver. This may be encoded with one or more simple thresholding bits, or less preferably analog values, encoded into the output of the transponder. Additionally, or alternatively, the transponder can generate a NULL transmission to the transceiver when it is running low of power, wherein it indicates that no user event has occurred but that power is running low.

The following describes an embodiment of the communication between the transponder and the transceiver. Upon receiving a first RF signal from the transceiver, such as by way of inductive or RF coupling from the transceiver, the transponder encodes (i.e. via a simple clocked shift register) information about the setting of the selection controls and outputs a second RF signal which responds to the challenge, or it alters the magnetic field to be read by the reader. Alternatively, the challenge may be utilized to store energy, and it may be coded with information from the audio system associated with the transceiver as to how the transponder is to perform, such as setting a mode of operation.

In general, transponders are often also referred to as RFID tags. It will be appreciated that conventional passive RFID tags respond to a challenge by immediately transmitting a predetermined response. These simple RFID tags are utilized in product control tags that may transmit a fixed response or a predetermine response to a challenge from which they receive operating power. Advanced RFID applications, such as keyless entry systems, are in some cases capable of generating a key code sequence, for instance a rolling code sequence, that provides a form of encryption for a pre-determined single key, or seed, that is passed to the transceiver from the transponder.

In summary, it will be appreciated that the RFID tag can be configured to register a challenge and to use the power derived from the challenge for transmitting its response. The RFID tag may also store power from a prior challenge for generating a subsequent transmission. In this way, the transponder can be triggered by a user and can respond to the event in real time, without waiting for a subsequent challenge to be received. Additionally, the storage of energy for a duration that can significantly exceed the time span of the challenge, allows for the sending of repeated challenges at lower intervals, wherein the challenges only need be sent for recharging the transponder after a transmission, or sent with sufficient frequency so that the power in the storage device is not depleted. The transponder within the unit according to the invention provides for the encoding of external events into the transmissions of the transponder.

It should be appreciated that the user-interface of the present invention may be alternatively attached or incorporated at other locations within the vehicle, such as on a center portion of the steering wheel (such as near/over the conventional horn region), stick-shift knob, door interior, center console, dash-board, and similar locations.

The transceiver, or transponder “reader device” as it may be referred to, is preferably incorporated within a vehicle audio system, however, it may be alternatively incorporated within other forms of electronic equipment such as moving map display controls, vehicle trip computers, cellular phones interfaced to the vehicle, PDAs and similar interfaced to the vehicle, and so forth. Additionally, the input device and transceiver may be associated with a non-automotive application, such as a transponder unit attached to another moving or interactive element communicating to any device configured for generating audio.

It will be recognized that the reader device (transceiver) is preferably configured to generate the power being coupled to the transponder and for reading the response of one or more transponders. By incorporating an ID within the challenge, multiple transponder units may be polled by the reader device, so that multiple input devices may be read. The interface device may be provided with other forms of sensors, such as an acoustic transducer, which digitally encodes audio voiced from the user and transmits it in response to the challenge. The reader device in this case can utilize the audio for mixing with the audio system output so that the singing or speaking of the user is then output by the sound system; preferably at the relative volume level as selected by the user.

FIG. 1 exemplifies an embodiment of a passive transponder-equipped component control system 10 mounted within a steering wheel 12 which is proximal to a sound system 14, or similar control equipment, to which a “transponder reader” (transceiver) 15 is operably coupled to remotely read transponder output. Reader 15 within sound system 14 is configured with an inductive loop 16, RF transceiver section 18, and decoder 20 (may optionally include encoding of commands or other information for transmission within the challenge) that in combination are capable of coupling power to one or more remote transponders and reading back data therefrom.

The data read from the transponder is decoded according to the application within decoder 20 and may be utilized within sound system 14 as events to trigger sound synthesis, to dynamically control audio parameters “on the fly” (i.e. sound warping [amplitude and/or frequency shifting] and so forth), or to control any desired application, (such as volume control, programming source, and similar typical audio front-panel control functions), or to control dynamic mixing of audio within the audio system. The audio system is shown containing a user-interface and controller 22, an auxiliary section 23, a tuner/CD/cassette section 24, a mixer and sound generation section 26, a DSP section 27 with microphones 28a, 28b, and an amplifier section 29 which is shown for driving a set of speakers 30a, 30b.

User interface and controller 22 preferably comprises generally typical front panel controls coupled to a microprocessor or microcontroller which controls the operation of the audio system, system adapted for generating audio, or for controlling other operational elements. The user interface displays settings, such as volume, station, and so forth while collecting user selection input for the control of the sound system.

Auxiliary section 23 is an option within the sound system which allows the data received from the transponder to be formatted into a preferably standardized format and communicated for controlling other equipment, for example, lights, shocks, and so forth. The sound system thereby provides a transponder read head from which any number of auxiliary functions may be ganged for control thereof.

A tuner/CD/cassette/MP3 section 24, also referred to as “audio source” 24 is configured to allow playing of various forms of programmed audio sources, which may include radio tuners, CDs, DVDs, cassettes, MP3s, data cartridges, wireless internet radio, and other forms of audio content sources and/or data storage elements. The operation of the audio source is preferably controlled by the user interface and controller 22.

Mixer and sound generator 26 is capable of modifying, either digitally or by analog mixing, the audio data stream from audio source 24, and can generate music, or other sounds in response to inputs such as from the user interface or the transponder data being received and decoded.

An optional section is shown within audio system 10 comprising a digital signal processing element 27 coupled with a pair of microphones 28a, 28b. The microphones are utilized for registering the level of sound both internal to the vehicle cabin and preferably also external to the vehicle. The first microphone 28a within the cabin can distinguish ambient sounds from that generated by the sound system, wherein the volume level of the sound system can be modulated in response to the ambient noise level to improve the listening environment wherein the volume level need not be changed when driving conditions change. The second microphone 28b is external to the vehicle and is configured to register sounds on the external vehicle environment, wherein aspects of audio system output, such as amplitude, may be modulated according to the prevailing conditions outside of the vehicle.

It will be appreciated that the use of a sound system while driving a motor vehicle can hinder the ability of the driver to discern sounds associated with external events, such as nearby emergency vehicles, and emergency situations. The second microphone 28b in combination with digital signal processing element 27, registers the external sounds and compares these with a set of emergency conditions within memory. When a match is made then the volume level of the sound system is attenuated, or is otherwise controlled, for a sufficient duration to allow the driver to properly discern the underlying event and take appropriate action. In addition, the sound system may generate additional warning information, such as audible sounds to alert the driver of the detected condition. It should be appreciated that the acoustic isolation provided by the nearly sound proof interiors of many vehicles can prevent proper recognition of roadway conditions. This aspect of the invention shares some features and implementation with the copending application “A System and Method For Selective Control of Acoustic Isolation in Headsets” serial number 09/841,713, filed Apr. 24, 2001, which is to be included herein by reference.

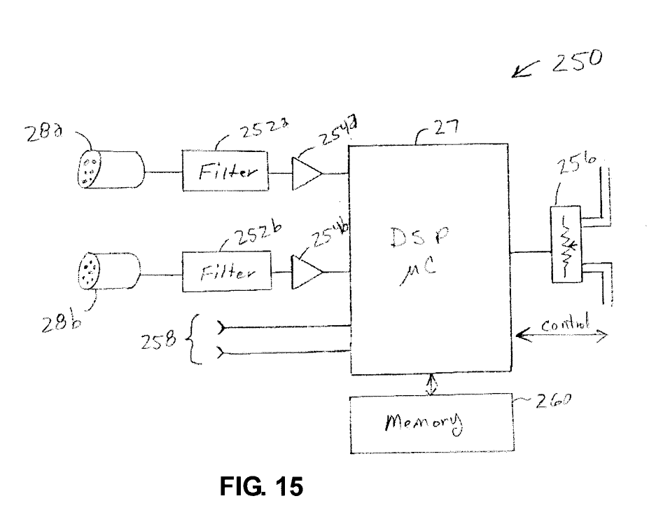

FIG. 15 illustrates a detailed view of the sound system volume control which will be describe in detail later.

Finally, an amplifier section 29 receives the audio information and drives a set of speakers depicted as 30a, 30b. The amplification provided may be modulated separately or by way of altering the amplitude of the signal fed to the amplifier. It will be appreciated that the amplifier may be of a conventional analog nature (i.e. Class A, B, etc.) or utilize digital amplification and control (i.e. Class D).

Steering wheel 12 is configured with a surface 34, (i.e. integrated therein or provided by using an “overwrap”) that is adapted with a series of input sensors, herein depicted as switches 36, and switches 38 which are coupled to a transponder device 40 having an inductive loop 42, shown surrounding the steering wheel. The sensors 36, 38 are operated by the driver, and the activation information thereto is communicated from transponder 40 to a transceiver 15 (also referred to as a reader unit) that is integrated with or coupled to audio system 14.

It will be appreciated that a number of transponder circuits are available, such as for remote-keyless entry, and for product ID tags. By way of example and not of limitation, upper sensors 36 may be configured to operate as piano keys, wherein their operation is interpreted upon being communicated by transponder 40 to said audio system 14 as the keys of a piano wherein the sound generator creates the appropriate notes for playback on the sound system. Preferably, the notes being generated are mixed with any existing audio source being played, at a relative volume level that is selected by the user. The lower sensors 38 are preferably utilized for controlling aspects of the sound system, such as channel selection, volume, and so forth as would normally be performed with the front panel. It will be appreciated that reaching to operate front panel controls while driving is both dangerous and inconvenient, whereas the present invention provides an improved control mechanism. By way of further example, the sensors may be configured to operate as percussion drum-pads, strings, or other forms of instruments, or audio control selectors.

In operation, transceiver 15 coupled to audio system 14 generates inductive signals on inductive loop 16 which are coupled to the coil 42 of transponder 40. The settings of the sensors 36, 38 are then registered by transponder 40 which issues a response to the challenge. The response is registered by the transceiver 15 within audio system 14 which interprets the settings of the sensors to control the sound system and any auxiliary equipment accordingly. As previously mentioned, switch sensors 36, 38, or other sensor forms, which are connected to the transponder can be interpreted by a transceiver (reader unit) 18 within sound system 14, or equivalent, as musical notes, rhythm, control inputs, warp/mixing inputs.

By way of example and not limitation, switch inputs 36 are interpreted as a series of piano keys, such that upon detection of their activation by reader unit 15, causes mixer and sound generator 26 to output notes into the audio stream being reproduced by the speakers 30a, 30b. The lower sensors 38 are shown by way of example as control inputs, such as for controlling volume levels and other functions. It will be appreciated that inadvertent contact with the sense inputs may be qualified by requiring the user to operate the sense inputs for a period of time to gain response, to use them in combination, and/or to utilize the control inputs according to predetermined timing patterns so that intentional contact may be readily discerned from inadvertent contact.

An optional display 39 is shown which is equipped with a transponder for receiving inputs for programming the display. The display is preferably provided by way of a low-power, non-volatile display technology, such as one utilizing electronic ink that only requires power for creating electric fields when altering the state of the pixels within the display. The display may be incorporated with the interface device 12, or utilized as a separate display. As utilized within a vehicle, the display can be programmed by the reader-equipped system 14, such as a sound system, to display information to the driver or to other motorists. Information may be provided to augment the interface of the device 14 associated with (reader unit) transceiver 15, or utilized to convey other forms of information. For example, the display can allow the driver to communicate visual information to nearby motorists. Incorporation of a transponder within the display allows the display to be implemented as a passive device that may be arbitrarily located, so long as it remains sufficiently near the reader unit 15 to receive power and signal therefrom. To increase the safety of using the display, the input from the driver may be optionally received as voice commands by the digital signal processing unit 27, whereby the matched voice commands directs what is to be output on display 39. It will be appreciated that such a display may be mounted on the inside of a window wherein the driver may communicate with the drivers of other vehicles. Furthermore, the display may be programmed to scroll for displaying large messages, and provide other conventional display affects. It should be appreciated that the above voice controlled display may be implemented separately from the tactile user inputs being registered upon steering wheel 12.

FIG. 2 exemplifies a transponder device 40 and an RF section 18 with inductive coil 16. Connected to transponder 40 is an inductive loop 42, it will be appreciated that utilizing a larger coil and a higher number of windings thereof will increase the range between the transponder and the reader. When joined with the steering wheel, it will be appreciated that coil 42 may be implemented to surround the perimeter of the steering wheel or any desired portion thereof, whereas typically the size constraints on the inductor/antenna limit transponder range. The design of the coupling between the transponder and reader are known to those of ordinary skill in the art. A clock signal and circuit power are extracted from the signal received by transponder 40 by way of a clock circuit 44, and extracted power circuit 46. A capacitor 47 is shown for storing the charge received from the challenge. High-value capacitors may be utilized, such as those which may be manufactured in a flexible flat configuration, to store energy for retaining memory and/or for use when generating a response.

It will be appreciated that the capacitor may be charged to any desired level of voltage or charge if the transponder receives more charge per challenge than is being expended in responding to the challenge. For example, sufficient charge may be received with multiple non-responsive (NULL) challenges, to provide a programming voltage for a FLASH RAM or similar non-volatile data storage device. A memory device 48 is utilized for retaining any desired response information, such as a responsive ID. In addition, the transponder may be equipped with additional control circuits which may derive parameters from the memory to determine their operation. A microcontroller circuit (not shown) may be optionally incorporated within the transponder to execute enhanced levels of functionality, however, in many cases the power required by a microcontroller will require the addition of a small battery to sustain microprocessor power. An encoder circuit 50 is configured to encode data into a format for transmission within the responsive output of transponder 40. An input section, in the form of a parallel-to-serial converter 52 is shown connected to the sensor inputs 36, 38, shown as switches. It will be appreciated that other sensor forms may be alternatively incorporated, such as capacitive sensors, inductive sensors, Hall-effect sensors, as well as parametric forms of sensing such as acceleration, temperature and so forth. However, it should be appreciated that a switch contact generally provides the advantage of having a negligible power dissipation. The switches may alternatively be configured as a scan array, or similar, however, it will be appreciated that more advanced scan electronics are then required which increase the power dissipation of the device. Encoder 50 receives the input from memory 48 and parallel to serial converter 50, or other sensors, which is formatted, such as into an serial bit stream for simple ASK transmission (Amplitude Shift Keying) by modulator 54 within via output driver 56. It will be appreciated that different forms of transponders are available, and that wireless circuits, such as Blue-tooth™, may also be utilized to communicate between the steering-wheel mounted sensors and the device containing the reader circuits.

Still referring to FIG. 1 and FIG. 2, it will be noted that RF section 18 is shown within sound system 14 as depicted with an attached sense coil 16 through which energy is coupled to transponder 40 and from which the response of transponder 40 is registered. RF section 18 is shown configured for connection to a controller, which provides decoding of the response from one or more transponders and the optional encoding of a challenge to the transponder. Coil 16 is driven by power amplifier 58 and an oscillator 60 that is externally controlled. A challenge comprising a unit ID, a unit type number, or other form of data, may be encoded into the control of oscillator 60 for coupling through coil 16. Responses from the transponder, as registered by coil 16, are registered by detection circuits, exemplified as peak detector 62 followed by a filter and amplifier 64. The output of RF section 18 is then decoded to manipulate the sounds or other parameters being controlled.

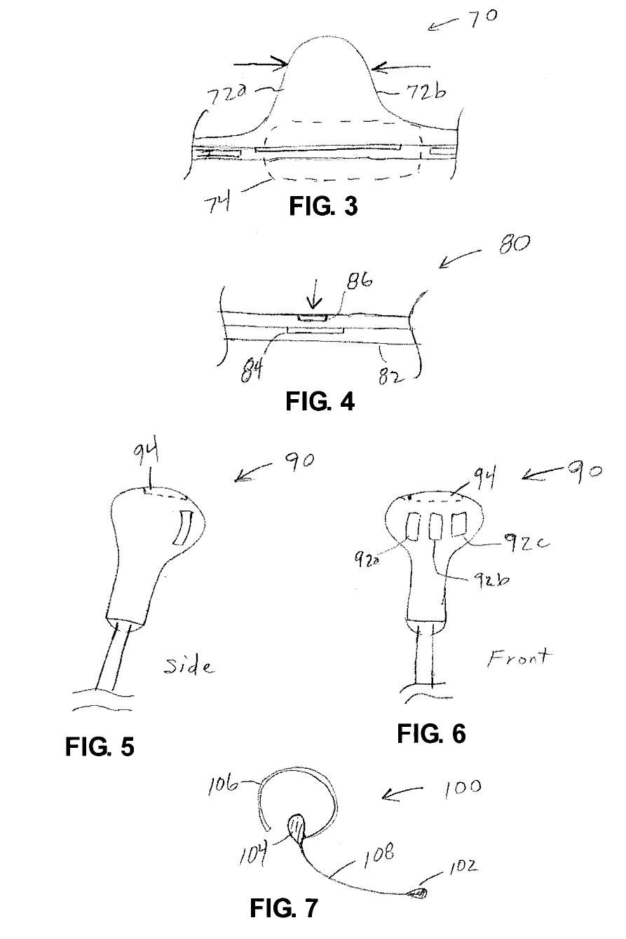

FIG. 3 illustrates a ridged sensor 70 which is configured to simulate a simple guitar string. Sufficient pressure on either side of the ridge 72a, 72b, activates one or more underlying switch 74 (or sensor output) which can be sensed by the transponder circuit. As mentioned previously, the use of a switch provides a low-power sense mechanism, however, a conventional switch is generally limited to sensing an on or off state and is unable to sense intermediate states, unless configured in an over lapping manner subject to different contact closure values.

FIG. 4 depicts another switch aspect of the invention 80 which provides for encoding intermediate states by utilizing a stack of switches having different activation pressure thresholds. Shown are a backing contact layer 82, proximal to a lower layer 84 that activates when in contact with backing 82 under a first activation pressure, and an upper layer 86 that activates upon contact with lower layer 84 when it contact backing layer 82 upon being subjected to a higher activation pressure. These switches can provide a digital output which encodes the activation pressure applied to the switch without drawing quiescent current from the circuit.

FIG. 5 and FIG. 6 illustrate an alternate interface 90 mounted to the shifting knob with three controls shown as 92a, 92b, 92c. The shifter may be configured as an aftermarket device or as an OEM option within the vehicle. A hatch 94 is shown on top of the shifter knob for setting other parameters of the controller and/or for the replacement of batteries, if used, on the device. The state of controls 92a, 92b, and 92C, are registered within the transponder for communication to a receiver.

FIG. 7 illustrates a voice input device 100 that contains a microphone 102 for registering a user's voice and a transponder 104 within the body of the unit for communicating voice information to the reader device. Voice input unit 100 is shown with an ear-clip 106 for mounting to the ear of the user and a boom 108 extending from the body of the unit for extending the position of microphone 102 proximal to the mouth of the user. The device can allow the use of voice commands, but preferably provides for the encoding of voice data, such as speech, or singing, to the reader for output over a sound system, megaphone, telephone, or similar audio device.

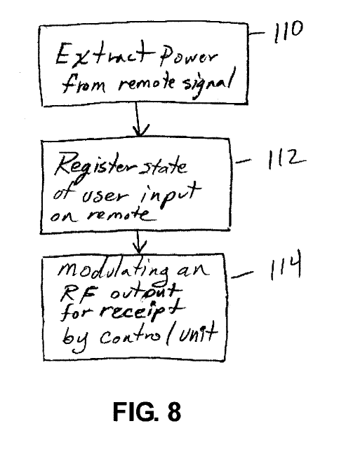

FIG. 8 illustrates a flowchart of an aspect of the present invention. Power is extracted from the signal at block 110, then the state of the user input at the remote interface is registered at block 112, followed by modulation of the output for receipt by the sound system or other unit, at block 114.

A transponder will be exemplified which can provide a number of additional features in relation to a traditional transponder element. It should be appreciated that these aspects of the invention may be practiced separately or in various combinations thereof without departing from the teaching of the present invention.

Another aspect of the present invention is the event encoding utilized on the transponder, wherein external dynamic inputs are registered, converted to a serial bit-stream, optionally combined with conventional ID information from the transponder, and utilized to modulate the output of the transponder for registration by the reader mechanism. The dynamic inputs register events occurring locally, and are not simply preprogrammed sequences or rolling preprogrammed sequencing. It will be appreciated that conventional transponder reader circuits may be utilized for generating power which is coupled to the transponder, and for registering responses from the transponder. It should further be appreciated that the reader may transmit encoded information to the transponder in the form of a challenge, to which the transponder responds with a response, either immediately, or upon the occurrence of a sufficiently significant event, such as user input.

Another aspect of the invention provides for the output of information contained within an encoded challenge transmission to a display, such as a non-volatile display as may be implemented with electronic paper formed with electronic ink retained between addressable conductive grids. The electronic paper may be implemented in the form of an adhesive-backed tag with electrode layers wherein all, or a portion of, the displayed writing, indicias, and bar codes are written to the display by the transponder in response to either environmental inputs, such as the previously mentioned switches, or the challenge. Utilizing a non-volatile display within the transponder is well suited to a number of applications. Articles, such as manufactured goods may be tagged with transponders having the electronic ink label. The label may then be programmed, such as with a bar code, a price, a UPC by generating a coded challenge having an ID that matches the transponder. Upon matching the coded challenge with internal ID data, the data from the received challenge is then written to the display. Using non-volatile display equipped transponder tags allows inventory to be performed en-masse wherein a group of units may be inventoried while they are still stacked up or stored on a palette. The incorporation of a display can also provide additional point of sale information such as indicating that the transponder is operational and has not been tampered with, by displaying at least one modulating visual element in response to the receipt of coded challenges.

Another aspect of the invention is the sensing of external stimulus, such as with switches, within the ID or within a delay element. Furthermore, a method is described for configuring a set of external switches according to locally set programming (simple programming near the point of use as opposed to programmed at the factory). Transponders equipped with the sense bits can be programmed with particular identification codes, or set with particular local encoding as described previously.

By way of example, external switches may be configured as closely spaced contacts over which a conductive ink may be selectively printed from a printer such as an inkjet printer, stick printer, or other forms of printers capable of locally applying a conductive ink to selected areas. It will be appreciated that if the electronics of the transponder are too thick to pass through the rollers of the traditional printer, the printer may be adapted so that the electronics are maintained to one side of the where the printing head overlays the portions of the label with the spots of conductive ink. The transponder tags may be manufactured in a series for tractor feeding within a printer. Using this technology allows the response of the transponder to be altered easily by an end-user/vendor near the point of use.

Another aspect of the invention describes the use of a programmed response delay element within the transponder, and a method is described for scanning a series of associated transponders. It will be appreciated that a number of situations exist in which a unit to be scanned comprises a series of sub-elements. It is often difficult to assure that the correct sub-elements are present within a given unit. Therefore, this aspect of the invention allows a series of transponder elements to respond to a single challenge which can be properly read by the reader. It will be appreciated that when multiple conventional transponder units are within range of the reader they respond to the challenge simultaneously whereby any data being passed back in response may be lost. In the present invention, these subunit IDs respond to either a generic or unit ID challenge according to a selected delay, the amount of which depends upon their subunit coding. Each response from a subunit may then be properly registered by the reader device, whether the transponders are being pinged en-masse such as for inventory, or in a unit group such as at a point of sale system. Upon receiving the challenge and matching the ID portion, or responding to a generic challenge, each of the subunit transponder elements generates a response that is subject to a slightly different delay wherein the reader element receives a response which is a combination response of all the subunits. Missing subunits, or incorrect subunits, within a given boxed unit may be remotely and readily detected.

Another aspect of the invention is that each transponder may be challenged with either a distinct unit ID challenge, or a general challenge. A distinct ID challenge is not responded to unless the ID within the challenge matches the ID of the transponder. This form of selective challenge is useful for scanning a series of units that are near the reader, such as for performing inventory. A general challenge matches any ID code, and returns the ID code of the transponder along with any additional information, such as external inputs being registered by the transponder. The general challenge is particularly applicable to point of sale use, wherein only a single unit is within the range of the reader. The incorporation of multi-use transponder elements provides a number of advantages for manufacturers, retailers, and other applications in which unit control is necessary.

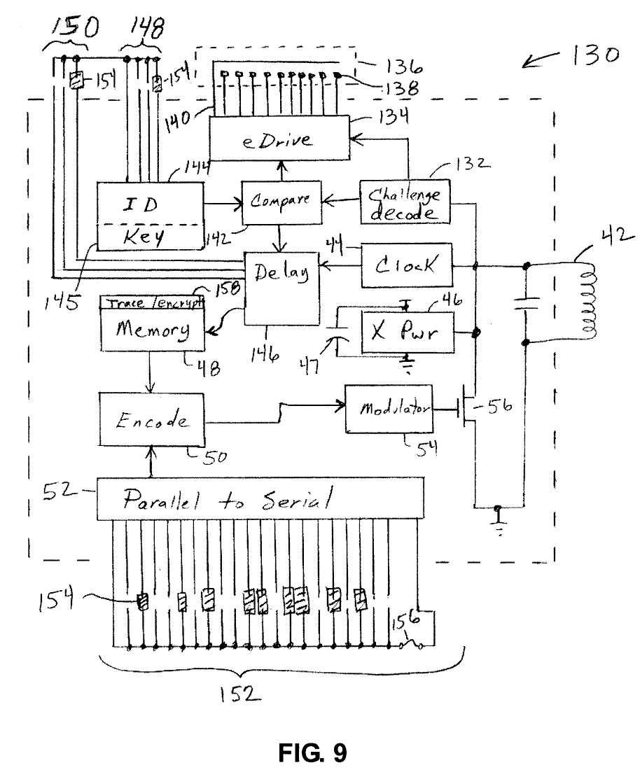

FIG. 9 depicts a transponder 130 which has been adapted with a number of features described above according to the present invention. It should be appreciated that these features may be incorporated singularly, or in combinations, and may be modified by one of ordinary skill in the art without departing from the teachings of the present invention. The transponder is depicted with a conventional inductive coil 42, along with a power extraction circuit 46 with power retention capacitor 47, and clock extraction circuit 44. The transponder is capable of registering challenges from a reader circuit (not shown) which are decoded with the challenge decoder circuit 132. The challenge may be output through a driver circuit 134 to a display, preferably a low-power non-volatile display such as an electronic ink display 136. Electronic ink displays are configured for orienting the colored “ink” within its microspheres in response to the polarity of voltage applied between one or more pixel electrodes 138 and a backplane 140.

The transponder may respond to general challenges or ID based challenges wherein a comparison circuit 142 compares the value from the challenge as decoded by the challenge decoder 132 with an encoded ID 144. A key field 145 is also depicted within the stored ID, this can contain stored information and an algorithm, such as a rolling code key value, which can be used to prevent non-authorized reader devices (those not having a proper password) from altering the information contained in transponder 130. Comparison circuit 142 is connected to a delay circuit 146 wherein upon matching with a unique ID challenge or a general challenge, delay circuit 146 can be triggered to time the response to the challenge so that multiple subunit responses may be generated for a single challenge. It will be appreciated, therefore, that a packaged unit containing subunits can be scanned using a general scan wherein all the subunits respond in a timed-sequence to the same challenge wherein the transponder for each subunit is configured with a different amount of delay. Depicted in the figure are auxiliary bits 148, 150 for altering the setting of the ID value, and the delay value respectively.

In addition, auxiliary sense bits 152 which can be returned within the response, are shown in the figure. The setting of these bits may be controlled in a number of ways utilizing a variety of switch, or state setting mechanisms. Preferred in the present invention are the application of conductive material 154 between one or more conductors, and the use of breakable conductive-link 156, and so forth which provide control of state at a low cost in a small amount of space. These inputs may be set manually, such as by marking boxes on a label with a conductive pen, whereunder the box a pair of conductive traces are joined by the application of the conductive marking. Alternatively, one or more conductive links 156 may be accessible for being severed manually or with a tool designed for it. Additionally, it will be appreciated that a collection of inputs may be set on a transponder tag by printing conductive ink over the contact pairs within an ink-jet printer or similar which is fitted with conductive ink within the cartridges. This, for example, allows tags/labels to be customized both with fixed indicias and text as well as information which will be reflected in the response information returned.

If the transponder is adapted with a sufficient number of adjacent conductive traces, then by printing the UPC code of the package over the conductive trace area the transponder can detect the inventory number of the particular unit. This method allows a merchant, or other business in need of tracking the units, to utilize generic transponders which are then customized during the printing operation to the specific units to which they are to be attached.

A portion 158 of memory 48 of transponder 130 is shown configured as a nonvolatile memory for retaining information such as trace information or additional encryption data for use within the transponder. The transponder circuit may be utilized within various tags, labels, and so forth. For example, the transponder element with the non-volatile eInk display can be utilized as a low-cost self-contained shelf tags for merchants, wherein the displayed price may be readily updated. Furthermore, the small size and cost of the device makes it particularly well suited for use in a number of forms of labels, such as adhesive-backed labels which are often used for merchandising. The use of trace information can allow the sequence of challenges to be recorded for tracking the activity to which the tag has been subjected. A tracking capability can be of high importance in many situations, for example in the case of tracking a package from a receiving point to delivery. If a substantially unique challenge is received by the tag at each node within the delivery system, such as when the package is “wanded” to enter it into the system, then the non-volatile memory retains a trace of each location to which the package has been sent. Furthermore, by encoding a date and time value within the challenge the timely flow of each package through the system can be checked by just reading all data back from the tag.

A further explanation on the use of subunit recognition within the transponder of FIG. 9 follows. Often a unit of merchandise comprises a number of associated elements. For example, a cordless electric drill kit may contain the following: drill unit, first battery, second battery, charger, set of tools, stand. Since merchandise is subject to return and theft, it will be recognized that every unit on the shelf of the merchant may not contain all intended elements. It will be appreciated further that the only current method of assuring that the unit contains all desired subunits is to perform a visual inspection in comparison with the parts list/instruction guide. However, inspections are rarely cost-effective and merchandise is often returned with missing parts and then resold with those missing parts.

Current transponders do not allow for the detection of a group of associated units, as they either generate a single general response or response to a challenge containing a unit ID. In either case, responses from multiple transponder units will contradict one another. The problem is especially troublesome at a point of purchase wherein a general proximal query triggers the response of the transponder, since the point of sale system is not searching for a particular transponder unit ID, and in fact does not know which unit is being scanned. The present invention, by contrast, provides a mechanism for associating a collection of transponders that are capable of responding to a general challenge, such as at a point of purchase. Each of the subunits transponders will respond to a challenge with a slightly different time offset, wherein the reader unit can discern what sub-elements are contained within the unit and can alert personnel if a problem exists with a return or purchase. Furthermore, one of the subunit transponders, such as the first one, may transmit a response which contains a value which specifies information about how many subunits are contained within the unit being scanned. It will be appreciated that information about the subunits may also be contained in the database of the merchant, or other business, that is performing the scanning of the tag. It will further be appreciated that subunit scanning may be utilized in a number of applications and business in which a series of related elements are to be scanned, or inventoried.

The transponder shown in FIG. 9 may also be configured to detect tampering with the transponder or the elements within the unit. A breakable conductive-link 156 can be configured as a separable portion of the transponder which adheres to the surface to which it is attached with greater force than that required to break link element 156, wherein upon removing the transponder from its point of attachment link element 156 breaks away from the body of the transponder, wherein the response of the transponder to a challenge will reflect the tampered condition of the transponder, such that remedial actions such as inspection may be performed. It will be appreciated that other portions of the circuit may be caused to separate and partially or wholly alter the operation of the transponder to allow for detection of the tampered condition.

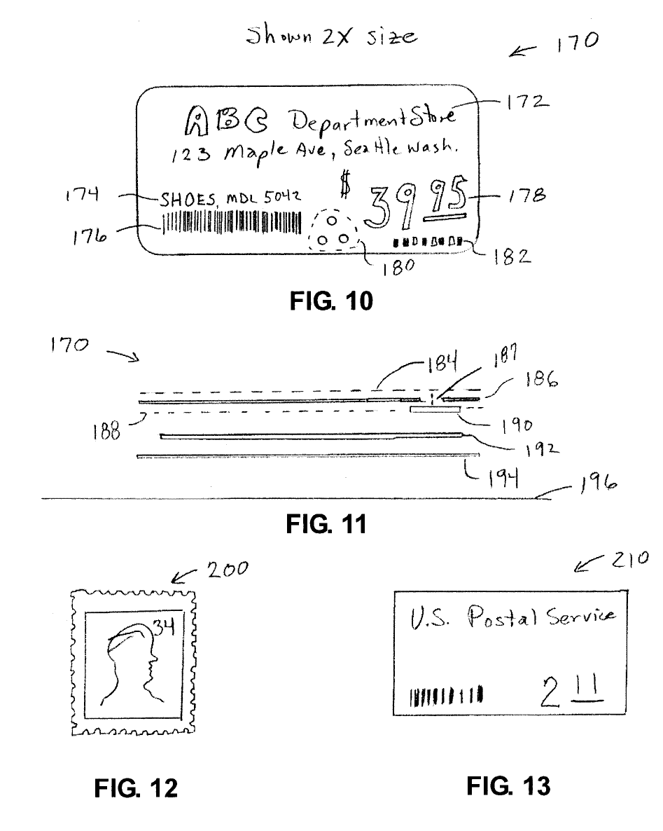

FIG. 10 and FIG. 11 depict a label 170, such as an adhesive packed packaging label, which contains the above-mentioned transponder element. As a packaging label the transponder can uniquely identify a particular unit, and can also selectively display information received from a reader on the label. Furthermore, the label can be easily hard-coded to contain certain forms of information or identification. In this way the transponder can operate to write to a display, such as preferably in the form of a label within which the transponder is enclosed. Label 170 has a fixed field 172 which may be preprinted or printed by the user as a function of stocking the item. A text product information field 174, and a UPC code 176 describe the product, and may be either a fixed field which is printed prior to application to the package unit, or comprised of a variable field implemented within the display, such as with electronic ink and underlying electrodes, to be output in response to one or more challenges received by the transponder within label 170. A price field 178, is preferably displayed by a section of the non-volatile display, such as electronic ink, wherein the price may be changed by simply sending an appropriately coded challenge to the transponder. An optional activity field is shown 180 for indicating that the transponder is operating correctly. The segments of activity field 180 are adapted to sequentially change color state in response to challenges being received by the unit to provide a visual indication that the challenges are being received by the unit. A series of conductive ink “pads” 182 have been shown applied over contact areas to set the state of selected inputs to the transponder within the label.

FIG. 11 depicts an exploded side view of the layers within the label of FIG. 10. A conductive mesh layer 184 may be incorporated over portions of the label to provide a backplane voltage for setting the state of areas containing electronic ink in response to electrode voltages. A facing material 186, preferably contains areas of electronic ink, and may be configured with apertures 187 through which electrical connections, or visual inspection of the underlying layer, are provided. A conductive electrode layer 188 is configured with the electrodes for driving the non-volatile display and is connected to a transponder 190. It will be appreciated that the inputs to the transponder may be set in response to altering areas within the conductive mesh or within electrode layer 188, or equivalent, wherein the transponder can sense the conductive state of given traces. For example, apertures within the facing material can allow the conductive inks to be printed to bridge over a sense gap between conductors within electrode layer 188. A capacitor layer 192 is optionally shown, which can store charge for use with responses, memory programming, memory retention, and other power-intensive activities. An adhesive-backing layer 194 is configured with an adhesive to allow for retaining the label upon a particular unit. A carrier-sheet 196 is configured for retaining a series of the labels positioned on the sheet to allow for printing and from which the labels may be easily removed.

FIG. 12 depicts another form of adhesive backed label 200, exemplified within a pre-printed postage stamp. This label may be configured with any of the aforementioned features, and is further capable of storing trace information within a small section of non-volatile trace memory 158 contained within the transponder as shown in FIG. 9. Upon receiving a store_trace challenge, which is preferably a form of general (non-ID-specific) challenge. Selected bits of the each challenge are programmed into the non-volatile memory as a trace for later retrieval. One application for challenge memory storage is for the storing of location information at locations along the routing of a package, parcel, or letter, such that the route that the package has taken through the system may be directly traced. The package need only be electronically scanned at each location to save the location information. A group of items containing the trace-enabled labels may be scanned en-masse if the storage of the trace location is subject to a qualifier, such as being unique within the value stored, so that the depth of the trace buffer is not wasted with data from redundant challenge pings. Furthermore, the storage of a date-time specifier, such as transmitted within the challenge, can further isolate the traversal of the item through the system. Utilizing a trace identifier allows routing details within any given process to be determined. The recent difficulties encountered with determining the origins of packages and letters containing a biological faction known as Anthrax, underscore the advantages of tracing the path and timing of how the package traverses within the system. It will be appreciated that a mail drop box can be configured to generate periodic challenges to all packages contained therein. The first unique location challenge received is stored within the trace locations, preferably along with date and time as generated by the reader circuit within the challenge. Another unique challenge may be issued at the time the packages are collected, wherein the date, time, and person performing the collection are registered, and so forth throughout the delivery system.

FIG. 13 illustrates a postage stamp 210 which is “printed” at the point of use. Traditionally stamping machines have been utilized to generate a label for a stamp of a sufficient value to provide for postage of the given article. Utilizing the present invention simplifies the reading and verification of these stamps by incorporating a transponder within which digital security features and information may be encoded. The memory within the transducer is loaded with a digitally encoded signature in response to information about the value, vendor, time, and location of the stamp being generated. This information may read by a reader device at any point in transit of the item being shipped. The encoded electronic signature is verifiable and unique, wherein the system eliminates the possibility of generating fake stamp imprints. The tracking feature described earlier may be incorporated within this point of use printed stamp. Furthermore, the label may even utilize an electronic ink label surface as previously described, wherein the value programmed into the transponder is automatically registered on the surface of the label as an amount. In this way the label may be programmed remotely, and the value of the label assured to match the setting of the encoded signature contained within the transponder.

Additional applications for a non-volatile memory equipped trace transponder include the manufacturing process, the fulfillment of orders, and other applications in which the ability to retrieve information about the aspects of a process sequence provide a competitive advantage. For example, the memory equipped transponder value may be loaded with other information, such as the identification of an inspector, lot codes, and so forth.

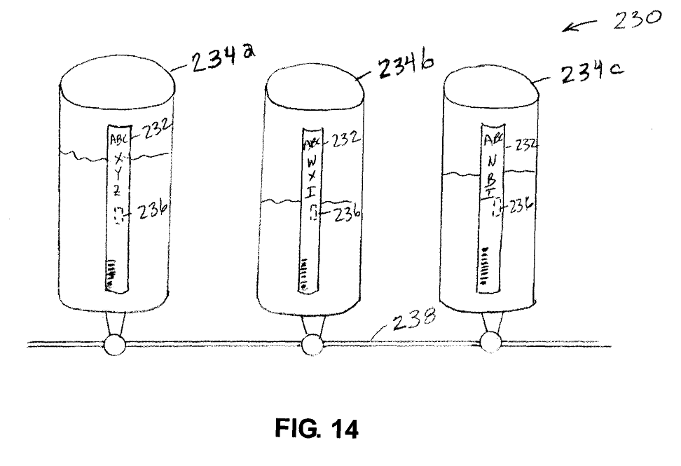

FIG. 14 illustrates an application 230 for transponders 232 equipped with sense inputs, such as shown by 36, 38, in FIG. 2, which are coupled to a fluidic level sensor(s) to sense the level of the liquid within each of cylinders the 234a-234c. The transponders 236 are shown embedded within labels, or elongated members, which are inserted within the cylinders. The level of the liquid in the cylinder is registered across a series of conductive pads on the back of the elongated members/labels which are connected to the transponder. The liquid in this instance is considered to be electrolytic and thereby alters the resistance across the contacts that are covered by the liquid. It will be appreciated that the transponder inputs may be coupled to alternative forms of sensor inputs such as weight, or unit count, wherein the transponder can automatically report inventory levels, or similar, for a specific device.

Returning to automobile control application, another aspect of the invention provides for modulating the volume of an audio system in response to the ambient noise within the vehicle or based on selected external noises. It should be appreciated that the audio system may be a car radio/tape/CD/DVD/MP3 style player, or other equipment that provides audio output, such as moving map displays, telephones, alert generators, interfaces to PDAs, and other devices generating an audio response. The sound from an internally directed microphone is compared with the audio being output from the audio system, the level of ambient noise is then utilized to control the volume level of the sound system, to normalize the volume for differing driving conditions.

It will be appreciated that drivers often must modulate the volume level to higher amplitudes during freeway driving when the internal sound levels are high from the engine and wind noise, and then turn the stereo system to lower amplitude levels when driving in the city. The present aspect of the invention can automatically correct for these changes, so that the perceived volume level remains the same.

Another problem which often arises is when external events are not being heard by the vehicle driver due to the amplitude of the sound system. An external microphone is therefore utilized in combination with digital signal processing circuits so that important sounds external to the vehicle such as sirens, screeching brakes, screams, crash sounds, and similar event-based acoustics can be discriminated from the sounds being registered. Upon registering one of these selected sounds, the amplitude of the sound system may be reduced, muted, or additional warning sounds generated, preferably depending on the severity of the event, wherein the driver is alerted to the event and can take appropriate action.

FIG. 15 was previously briefly introduced in relation with FIG. 1 for controlling the volume level, or similarly acoustic isolation-reducing characteristics, of an audio system within an automobile. FIG. 15 depicts the automatic audio system volume control with filters 252a, 252b, amplifiers 254a, 254b, an electronically variable potentiometer 256 for controlling volume level, and inputs 258 for receiving an audio signal from the sound system to be compared with the interior sound levels. A section of memory 260 is configured for retaining information about the exterior sounds which used for triggering volume reductions, as well as parameters for both the interior and exterior sound detection. It will be appreciated that the recognition of specific sounds is known to those of ordinary skill in the art, and therefore does not require a detailed explanation.

Another aspect of the present invention which relates to sound systems is a mixing control for automobile, or other sound systems. The sound system is configured to determine or register an ID for each sound recording to be played by the sound system. Each of the sound recordings need not provide a unique internal ID as the unit is capable of extracting selected bits across portions of the recording wherein it can be reasonably assured that the resultant ID will be unique for different music contained on separate recordings. In this way the unit can store information for each of the sound recordings based on ID and can thereby restore settings based on ID when a sound recording is being played for which data has been stored.

The sound system is then adapted with a set of mixing controls which allow the user to warp, slur, hop, slide, warble, fade, change balance and other forms of mixing while playing the sound recording. When set in a program. mode, one or more of these mixtures may be saved for a given recording ID, by storing a location parameter, such as a time offset and a section of the music as synchronization bits, along with parameters defining the change in state for the mixing controls. On playback the user can select to play the recording in a conventional mode or a “play mix” mode. In “play mix” mode the selected effects are applied at the proper time within the recording to play the user's custom mixed pieces. In this way the user is able to create custom mixes of tunes that may then be played back when desired. The system can be configured to store multiple mixes for a single recording wherein the user can select which mix they want to use when electing the “play mix” mode. Furthermore, if the sound system incorporates a writeable sound recording media, such as writeable CD, or DVD, then the system can store the mix data directly on the recording media, wherein the memory space within the sound system need not be taken up with mix data.

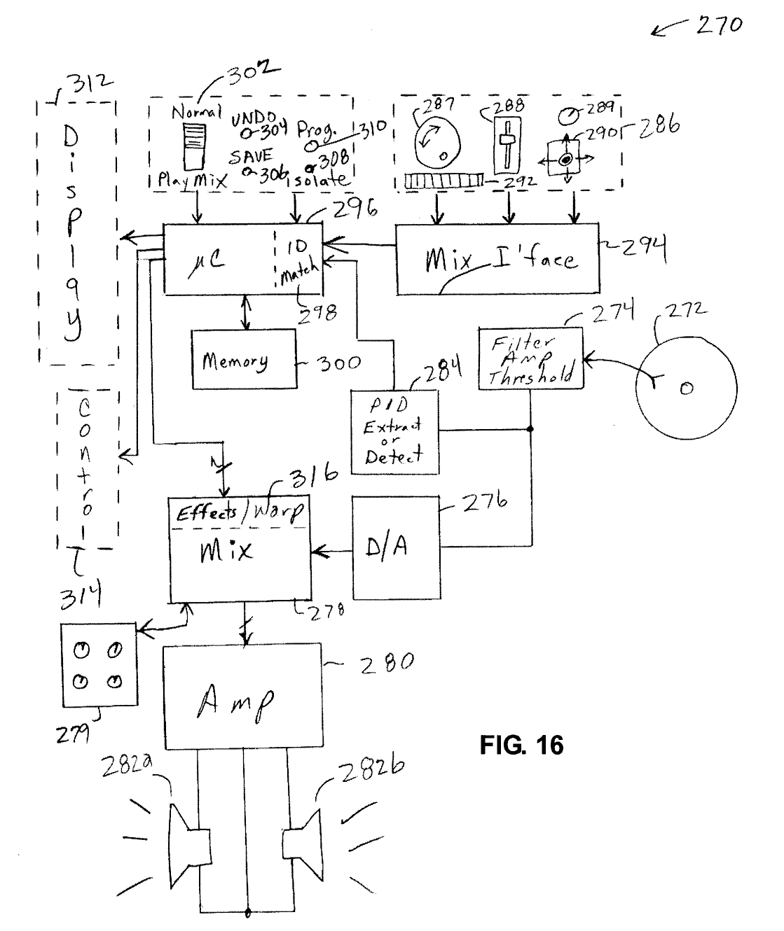

FIG. 16 depicts the mix memory feature 270 which may be incorporated within sound systems, such as automotive sound systems. It will be appreciated that when playing music, such as a CD or other audio programming source, a user may prefer not only to eliminate a given track of the CD from playback, but to change or even dynamically modulate a parameter such as volume, tone, or special effects within the piece as it plays, or to introduce special effects, warping, spinning, and so forth in synchronization with the music so as to customize the piece of music. The feature described is a mix-memory that may be implemented within any sound system.

The user can set parameters for establishing a “mix” for the tracks within a CD being played. The user can select MixMemory mode and then as the CD is played their parameter changes are saved as a control sequence in reference to location specifiers of the piece being played. In this way the user can select to play the CD later in the normal mode, or to play the CD mixed according to their preference. In addition, the unit can allow special effects to be added in, such as that reversing record sound, reverb, warping, etc. It will be appreciated that various forms of effects are utilized by disc-jockeys and with musical instruments, such as guitars, and so forth. This system is capable of supporting these effects, and storing them for the particular CD without altering the contents of the CD itself, or a copy thereof. It is contemplated that this feature could become especially popular with young people interested in cars and their sound systems, as they will gain the ability to customize their own versions of their music to “impress” one another.

Mix-memory system 270 is preferably designed for use with digitally stored musical equipment due to the simplicity of synchronization and storage. It will be appreciated that it is easier to generate location keys directly off of digital info rather than first covert analog to digital for checking and storage. The player can ID each unit of audio storage media, such as a CD by a serial number, or may take a preselected audio sampling at a few locations within the media to generate a unique ID for each unique CD played. The player already knows the track number and time into each track, these parameters are stored with any change as a time offset into the track, and a change. The unit obviously is better suited for using electronic controls, as opposed to manual potentiometers, for controlling the parameter settings.

Additional elements, such as the voice (singing) of the user may even be added to the mix, such as by the interior microphone 28a previously described for FIG. 1, although this requires a large amount of memory space for each unit for which audio is to be retained. Therefore, such content would be preferably stored in a compressed form, such as MP3, or similar low data rate formats. The mix may be stored within the audio media if it the sound system is configured for writing to the media, wherein any limitations on the size of the mix parameters could be eliminated, and the user would then be able to take their “mixed” music composition with them for playing on other sound systems equipped with the same forms of mixing controls.

In view of the foregoing, it will be appreciated that manufacturers should standardize the mixing functions and the encoding of these mixing functions such that media could be interchanged between different sound systems and will still provide similar mixing results.

An audio media 272, such as a CD, is shown connected to a reader device 274, such as comprising filters, amplifiers, and detectors for reading data from a CD. Within a sound system the data may be converted to audio by an D/A converter 276, then mixed 278 according to a set of controls, such as volume, bass, treble, and fader, within conventional audio sound controls 279, which is then amplified within an amplifier 280 for output to a set of speakers 282a, 282b. It will be appreciated that the audio data need not be converted prior to mixing, and in fact with the use of a Class D amplifier the output from the sound system may be in the form of digital data. The mixing, therefore, may be performed according to the present invention as either analog mixing, digital mixing, or a combination thereof.

The system provides a mechanism 284 for distinguishing each unique audio media being played on the sound system. For example, the unit may extract an ID from the media, or utilize a sampling algorithm wherein locations within the audio media are sampled to generate an identification for the media. A set of mixing controls 286 is provided for the user to control aspects of the desired mix for a particular audio track being played. Exemplifying these controls is a juke-spinner 287, which provides for warping of the sound in a similar fashion to that produced when hand-spin controlling a vinyl analog LP recording, a bass control 288, a volume control 289, a joystick fader control 290, a small keyboard 292 for generating notes or effects. It should be appreciated that any form of audio mixing control or special effects generation may be utilized to provide input for the system as received by a mixing interface 294, which encodes the values on the mixing controls for use within the system. A control device 296, such as microcontroller, receives the mixing information. It should also be appreciated that the mixing interface for an automotive application is preferably implemented as a separable unit that connects to an audio system by wire or more preferably wirelessly.

Microcontroller 296 is configured with programming 298 to provide for the matching of the ID from the audio media being played with information from memory 300, so as to look up mix parameters for a particular audio media, and to store mix parameters being input for a particular media. It will be appreciated that any mix inputs are registered for a given track to be synchronized with the music within the track. The present system may provide synchronization by way of storing sound segments for matching, or by storing time offsets. Time offsets are preferable utilized as they provide for a simple and space efficient location mechanisms, although higher synchronization accuracy may be achieved by verifying the exact location with a stored “sound bite” taken when the mix element is programmed. Preferably, the mixing may be added cumulatively for each track being played, and the user can also elect to erase all or portions of the mix information. An undo button is preferably incorporated wherein the user can attempt various mixes, test them and then elect to either undo them, or save them to memory for later retrieval. Microcontroller 296 is shown with additional inputs normal/play-mix 302 wherein the user can select to play from the audio source in a normal (unmixed mode) or to match up and use any programmed mix settings. An “UNDO” button 304 and a “SAVE” button 306 provide some measure of control to allow for the removal of selected mix features and an “ISOLATE” button 308 allows the user to isolate any of the previously saved mix elements for the track for selective removal. A “PROGRAM” mode selector 310 can be engaged when the user desires to program the mix settings, rather than just temporarily introducing the mix variables to the track.

An optional display 312 may be utilized for displaying information about the mix. It will be appreciated that this display may be a separate display for displaying mix parameters or be part of the sound system into which the mix features are incorporated.

An optional control module 314, when coupled to selected controls, can allow the user to control auxiliary equipment which will remain in synch with the programmed music. For example, the user may want to choreograph the operation of the pneumatic shock-absorbers, lights, or horns, with a particular musical track. The user can input these auxiliary selections by way of additional control inputs, such as switches, potentiometers, and so forth, during programming of mix for the track. These controls are then placed in synchronous with the music and during subsequent playback will modulate the output of control module 314 to control the shock-absorbers, lights, horns, and so forth accordingly.

Microcontroller 296 outputs mix control information, which is preferably the combination of the mix being input by the user on the controls 286 and any previously programmed mix contained within memory 300, or that has been previously programmed into the audio media 272 itself (if a writable media is utilized). The mix control information is received by a mix effects/warping section 316 of the mixer wherein it modulates the audio generated from the audio media accordingly and in combination with other conventional mixing controls 279 prior to output through the amplifier 280 to the speakers 282a, 282b.

Another aspect of the present invention combines remote controlling elements as described above within a skateboard, or similar typically non-musical apparatus, to provide for the control of a sound source, such as mixing control or direct sound generation in response to the motions and use of the skateboard. This invention allows turning a skateboard into a musical instrument or a rap control mixer that is controlled by the movements of the rider.

By way of example, a skateboard is configured with a activity state sensors, such as a pressure sensing top surface, angle sensing, rate of turn sensing, and acceleration sensing, which are coupled to a transponder similar to that described for use with the steering wheel. An audio system, such as an individual audio system, portable sound system (“boombox”) or equivalent forms of audio system are configured with a transponder reader capable of registering the application of pressure to the top of the skateboard. The transponder in this case, however, is preferably augmented with a battery to allow amplifying the transponder signal to increase the allowable range between the sound system and the skateboard.

Changes to the applied force, turn rate, and acceleration of the skate board can then be converted within the sound system to a dynamic audio composition sequence or a dynamic audio control sequence. For example, the skateboard can be utilized for auxiliary music accompaniment, such as by converting the pressure inputs on the top surface into keyboard styles notes, percussion, sound effects, and so forth, or for controlling the mix of music (amplitude, balance, warping, synchronization, and other forms of audio control) in response to the motions of the ride and interaction with the skateboard sensors.

It will be appreciated that a rider of such a skateboard will be capable of choreographing their movements with the music, creating music in response to riding their board, or generated effects and mixture controls that follow their movements on the skateboard. An audio dimension is thereby added to the skateboarding experience. Multiple skateboarders can even form “bands” wherein their collective control of their boards is registered by a single sound system. It should also be appreciated that skateboard may be configured with sensing top decks that provide various forms of sensing. For example, a percussion deck which sensing tapping or sliding movements over large areas to effect the control of percussion; or a strings deck which has sensing elements directed to controlling a stringed instrument, and so forth.

The transponder utilized with these specialized decks preferably generates a challenge response that contains a type code which identifies the type of deck being utilized, so that the reader within the sound system will understand how the data being received from the unit is to be interpreted. The sound system is also preferably configured to allow the user to program the parameters of the interpretation, so that they can select how they want to control the music. It will be appreciated that the sound system generates the audio or creates the music to be played or mixed with a microprocessor, or other programmed element, that interprets the data from the skateboard in response to a set of parameters about how the audio should be altered in response. The parameters controlling the relationship between the data received from the skateboard and the audio being produced may also be loaded from external sources, such as from data cartridges, data CDs, data which is downloaded and so forth. The user therefore, can alter the way in which their skateboard controls the music by selecting alternate parameter sets, such as perhaps those downloaded from a web site associated with the skateboard.

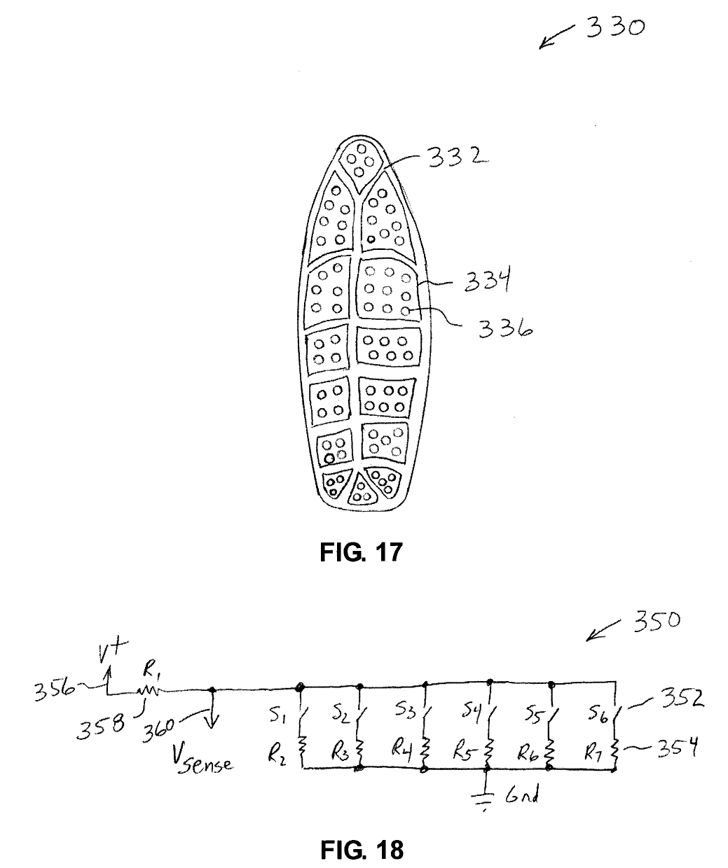

FIG. 17 exemplifies an embodiment 330 of a skateboard having sense inputs, such as a pressure sensitive top deck, for the creation and/or control of audio sources (music). The skateboard is responsive to user input and communicates the information, such as by an RF-link, to an audio system (not shown). The skateboard is preferably configured with one or more forms of user input device. The inputs are utilized in similar manner to that of the steering wheel device of FIG. 1 wherein operation by the user is registered and transmitted to a reader device which incorporates or controls an audio system to dynamically generate musical notes or other musical effects, such as warping, and so forth, as a data stream to a remote audio unit.

A sensing top-deck 332 is shown in FIG. 17 by way of example. The top deck is configured with sensors for detecting contact with portions of the top deck. The sensors may operate utilizing any of a number of detection principles known to those of ordinary skill in the art, which include a pressure sensing surface, pressure sensitive switch contacts, capacitive sensors, inductive sensors, and hall-effect sensors that can detect the position and movement of embedded shoe magnets of the rider. Skateboard 330 is shown divided into regions 334, each of which incorporates a series of domed switches 336 which change state upon the sufficient application of pressure, such as by the feet of the rider. The sensors of the top surface are shown grouped into slightly different functions, wherein the series of switches within each function are grouped.

FIG. 18 exemplifies a circuit 350 which groups a series of dome switches 352 within a membrane switch panel to allow the control unit to discern the relative state of the switches, so that it can determines how many switches within the group are in each state. The switches are placed in parallel and each switch is placed in series with a resistor 354, to which a voltage 356 is applied through a sense resistor 358. The number of switches 352 which are closed can be determined by registering the voltage at sense point 360 by virtue of the resistive divider thus formed. The input from a group of switches can be easily measured by the microprocessor by utilizing the sense voltage to charge a discharged capacitor, wherein the time required to charge the capacitor is a determiner of the voltage; after which the capacitor is discharged awaiting a subsequent sense cycle. It will be readily appreciated by those of ordinary skill in the art that sensing of pressure may be implemented according to a number of alternative methods.

The RF output from the skateboard is altered in response to the operation of the skateboard, which is received by a remote unit that is configured with a reader as described for use with FIG. 1, and having a similar structure to the mix-memory described in FIG. 16. It will be appreciated that due to the expected distance and variable nature of that distance, a battery powered RF communication system, such as according to the Bluetooth™ standard, should be preferably utilized for communicating with the remote reader device. It will be appreciated that a powered RF transponder may be alternatively utilized.

The skateboard is preferably configured to sense a number of operational variables, such as deck pressure, overall skateboard acceleration, and wheel speed. These variables are registered by the control unit within the skateboard and transmitted to the remote reader unit which then translates the variables into musical notes, or by altering a sound stream, such as from any source of audio programming, (i.e. CD, MP3, radio, and so forth).

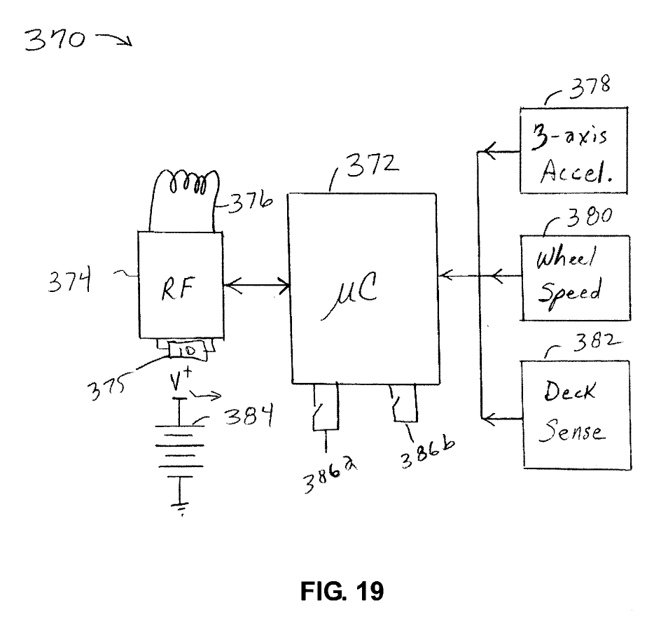

FIG. 19 illustrates a circuit 370 for the skateboard which may be utilized for controlling registering the operation of the skateboard and transmitting that information to a remote reader device. A control circuit 372, preferably a microcontroller or similar, is connected to a set of input devices comprising a three-axis accelerometer 378, a wheel speed detection circuit 380, and one or more deck pressure sensors 382. Acceleration sensors are readily available for sensing from one to three axis of motion and may be directly interfaced with standard microprocessors. It will be appreciated that the sensing of deck tilt in relation the wheels may be alternatively, or additionally, performed by a variety of tilt sensors. Various methods, as described exist for sensing the pressure being applied to the top deck, or alternatively the position of the users feet on the deck.

The inexpensive sensing of wheel speed is slightly more problematic, due to the fact that the wheels are subject to wear and users may replace the wheels on the board with other wheels that may not even be of the same diameter or size. One simple method of sensing wheel speed is the embedding of one or more magnets within the wheel or on the backside of a wheel, and utilizing a Hall effect or inductive sensor to count the rate at which the magnet passes the Hall effect device or other form of sensor.

Utilizing multiple sense inputs allows many aspects of skateboard operation to be translated into a dynamic musical note sequence, or dynamic musical modulation sequence. The operating variables registered by control circuit 372 are then output via an RF circuit 374 with antenna 376, or equivalent. Preferably the RF unit can be set for a specific channel, or with a programmed ID 375, wherein a series of skateboards may be coupled to a single remote sound system to allow “a band” to play music from a group of skateboards whose operation is being registered by a single sound system. A single RF channel may be utilized with randomly distributed transmission timing such that multiple units will not continually overlap the signals from one another.

Alternatively, a synchronization mechanism may be utilized, however, this generally involves additional complexity and cost. The unit is preferably powered by a battery source, although it may receive all or a portions of its power requirements from a solar cell, inductive coupling, and so forth. The sensors shown, and other similar sensors, may be utilized within the skateboard device separately or in combination with one another for registering the operation of the skateboard. In addition, control switches 386a, 386b, may be incorporated within the unit to allow the user to control the operation of the control circuit, or power, within the skateboard.

In use, the movement of the skateboard and the positioning of the riders feet and operation thereof are converted to an audio sequence or audio control sequence by the remote audio system. The effects created by the skateboard may be added to a programmed source of audio such as a writeable CD, or similar, or may be generated by way of modifying the audio stream of the programmed source, such as by warping, warbling, back-spinning, and so forth.

Preferably the user can select by way of the remote sound system what effects are to be generated in response to the operation of the skateboard. These skateboard may thus be programmed for different actions. The programming for the remote sound system in conjunction with the invention, can be retrieved by the user from a programming media, such as CD, that may be read by the sound system. Each program on the disk may be augmented with an audible text explanation and sample of the effects to be created by the disk. It will also be appreciated that programming for the skateboard may be provided for user selection from a web site or other means for distributing program content.

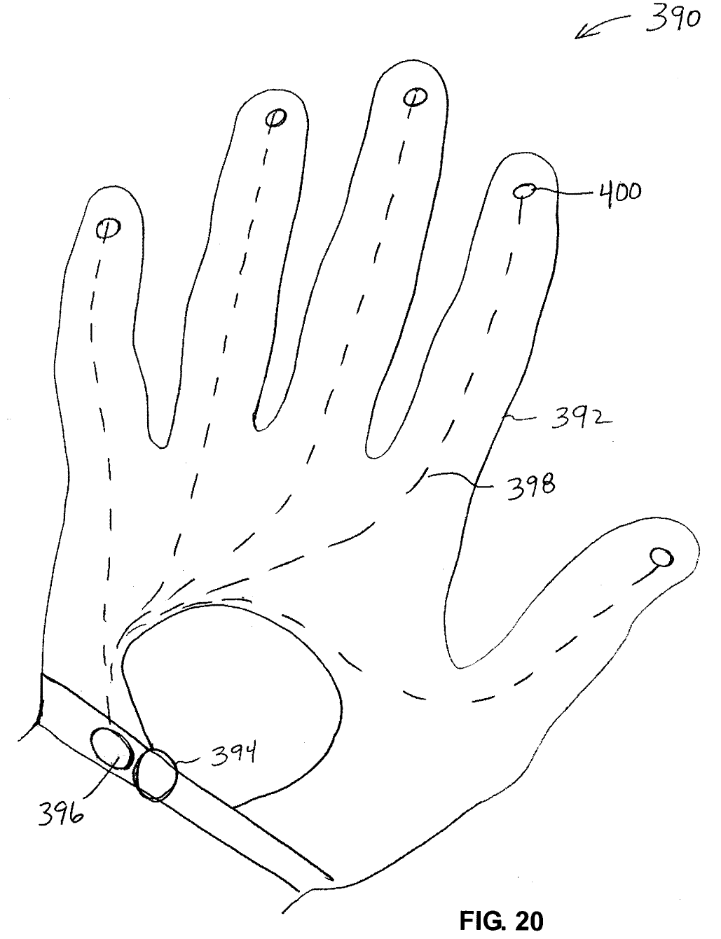

FIG. 20 depicts a similar application to that of the skateboard for controlling remote audio devices, wherein a wearable device, depicted as a glove 390, generates audio control outputs in response to the dynamic metrics registered on one or more sensors. A wearable member 392 is exemplified as a glove spanning a portion of at the users hand. A transponder unit 394 receives motion data from a input detection circuit 396 that is configured to read data through connections 398 from remote sensors 400. It will be appreciated that the sensors are responsive to user actions, such as acceleration, pressure, and so forth. The wearable sensor and transponder equipped garment can be utilized for generating audio sequences, such as an “air guitar” or for controlling audio sequences generated elsewhere, such as a conductor. The circuits are similar to those described for the automotive steering wheel transponder and mix-memory aspects of the invention.

Accordingly, it will be seen that this invention provides a number of fundamental features for use within transponder devices and a number of embodiments that employ one or more of those features to provide a unique product. It will be appreciated that the invention can be implemented in a variety of ways with additional embodiments, as will be recognized by one of ordinary skill in the art.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for wirelessly communicating dynamic event-based information from a transponder for delivery to a remote transceiver location, comprising:
(a) means for collecting electrical energy from a received challenge as transmitted by a remote transceiver;
(b) means for serializing detected events within the transponder into a bit-stream; and
(c) means for transmitting said bit-stream from said transponder using said collected electrical energy for powering said transmission.

2. An apparatus as recited in claim 1, wherein said means for collecting said electrical energy comprises an antenna coupled to a power supply and associated capacitor for extracting, regulating, and storing sufficient electrical energy. is derived from

3. An apparatus as recited in claim 1, further comprising a trace buffer for storing information about said challenges within non-volatile memory locations.

4. An apparatus as recited in claim 3, wherein said information is stored in said non-volatile memory if a desired portion of said data is unique to the entries that already exist within said non-volatile memory.

5. An apparatus as recited in claim 1, further comprising:
a location for retaining an identifier for the apparatus; and
a comparison circuit for comparing an identifier contained within a challenge from the remote transceiver and transmitting a response signal if a predetermined relationship exists between the identifiers.

6. An apparatus as recited in claim 5, wherein said predetermined relationship is that of matching.

7. An apparatus as recited in claim 5, further comprising a delay circuit configured to generate a predetermined delay between finding said predetermined relationship and the transmission a response.

8. An apparatus as recited in claim 7, wherein the length of said predetermined delay depends upon which element the ID is associated with within a group of said apparatus.

9. An apparatus as recited in claim 1, further comprising:
sense inputs for collecting dynamic event information; and
an encoder for serializing the dynamic event information bits prior to transmitting them as a response to a challenge from said remote transceiver.

10. An apparatus as recited in claim 9, wherein said sense inputs comprise switches whose state may be modulated by a user.

11. An apparatus as recited in claim 9, wherein said sense inputs comprise selectable jumpers that may be added or removed to change the state of said sense inputs.

12. An apparatus as recited in claim 11, wherein said selectable jumpers comprise breakable links configured for adhesively bonding to a surface with a strength exceeding the break strength of the bond wherein tampering can be detected.

13. An apparatus as recited in claim 1, further comprising a decoder for generating output signals for driving a textual or graphic display in response to display data encoded within said challenge.

14. An apparatus as recited in claim 13, wherein said decoder is configured for driving a non-volatile electronic ink display.

15. An apparatus as recited in claim 1, wherein said means for collecting said energy comprises a capacitive storage element.

16. An apparatus as recited in claim 15, wherein said capacitive storage element is configured to store a portion of the electrical power from a received challenge to power the circuit for a responsive transmission at some later time in response to an external event or a low energy condition within said energy storage device.

17. An apparatus for generating dynamic audio sequences or dynamically modulating audio from other sources in response to manipulation of an interface by a user, comprising:
a set of input sensors configured to register user inputs;
a transponder device coupled to set of said input sensors and configured to encode information from said sensors within a response transmission to a remote transceiver subsequent to receipt of a challenge from a remote transceiver;
a transceiver configured for sending challenge transmissions to said transponder device and registering encoded information from response transmissions from said transponder; and
a controller for generating dynamic audio sequences for output on an audio system or for generating dynamic audio control sequences for dynamically controlling the audio generated by an audio system.

18. An apparatus as recited in claim 17, wherein said set of input sensors comprises a set of pressure sensitive sensors for registering user finger contact.

19. An apparatus as recited in claim 18, wherein said pressure sensitive sensors are positioned beneath raised protrusions that upon receiving sufficient sideward pressure activate said underlying sensors.

20. An apparatus as recited in claim 18, wherein said input sensors are located on the steering wheel of an automobile.

21. An apparatus as recited in claim 19, wherein said input sensors are located on a cover which is configured for attachment over a steering wheel.

22. An apparatus as recited in claim 18, wherein said input sensors are located on a shifting knob, or similarly driver accessible surface within said automobile.

23. A label, comprising:
a printable front surface and a rear surface configured for attachment to a surface;
a transponder attached to said label and configured for being powered from a challenge received from a remote transceiver; and
a tracking circuit within said transponder configured for retaining information from challenges in which a portion of said challenge information meets predetermined requirements.

24. A label as recited in claim 23, wherein said predetermined requirements comprise a desired portion of the challenge identification not being already found within the retained information.

25. A label as recited in claim 23, wherein said information from said challenges includes a temporal specifier including a date and/or time value.

26. A label as recited in claim 23, further comprising:
a decoder for converting at least a portion of said information received within said challenge to outputs for controlling a display device; and
a display device positioned for viewing on said label and connected to said decoder for driving the state of the pixels therein.

27. A label as recited in claim 26, wherein said display comprises an electronic ink display.

28. A label as recited in claim 23, further comprising:
sensory inputs to said transponder; and
an encoder within said transponder for encoding signals from said sensory inputs within responsive transmissions.

29. A label, comprising:
a printable front surface and a rear surface configured for attachment to a surface;
a transponder attached to said label and configured for being powered from a challenge received from a remote transceiver; and
a decoder for converting at least a portion of said information received within said challenge to outputs for controlling a display device; and
a display device positioned for viewing on said label and connected to said decoder for driving the state of the pixels therein;
wherein said display comprises an electronic ink display.

30. An audio control device, comprising:
at least one acoustic sensor;
an output for controlling an audio system; and
a circuit for registering the acoustic signal from said sensor and generating a control signal for controlling the state of an audio system upon detection of a selected characteristics of said acoustic signal.

31. An audio control device as recited in claim 30, wherein said acoustic sensor registers ambient noise within the interior of the vehicle and maintains the amplitude of the sound system at a level which increase in response to increased ambient sound and decreases in response to decreased ambient sound levels.

32. An audio control device as recited in claim 30, wherein said acoustic sensor registers noise external to a vehicle and compares the acoustic signals against predetermined selection criterion to determine if the sound volume of the audio system should be reduced to allow the driver to hear important external sounds.

33. An audio control device as recited in claim 32, wherein said acoustic signals from said sensor are coupled to said audio system for reproducing the externals sounds which follow the predetermined selection criterion.

34. An apparatus for utilizing dynamic audio mix information for modulating the characteristics of an audio source, comprising:
means of identifying a particular audio selection and positions within said audio selection;
a user mix interface configured to allow a user to dynamically alter characteristics of the audio being output in response to said audio source;
a memory circuit configured for storing mix information with synchronizing data for the location and identity of the audio selection; and
wherein said mix information may be selectively input to said user mix interface to allow user to replay a mix which has been entered into said memory circuit.

35. A skateboard, comprising:
at least one sensor coupled to said skateboard that generates a signal in response to the variations in how the skateboard is being ridden; and
an audio circuit configured for synthesizing sounds, or audio control signals, in response to said riding signal.

36. A skateboard as recited in claim 35, further comprising a transponder coupled to said sensor for communicating said signal between said skateboard mounted sensor and an associated transceiver coupled to said audio circuit.

37. A skateboard as recited in claim 35, wherein said sensor may be selected from the group of sensors capable of distinguishing ride characteristics consisting of pressure sensitive switches, acceleration sensors, pressure sensors, speed sensors, wheel rotation sensors, rate of rotation sensors, impact sensors, inductive sensors, and capacitive sensors.
